(19) United States
(12) Patent Application Publication
(10) Pub. No.: US 2010/0274891 A1
(43) Pub. Date: Oct. 28, 2010

(54) NETWORK MONITORING SYSTEM AND METHOD

(75) Inventor: TSAI-HUNG LO, TAIPEI CITY (TW)

Correspondence Address: TSAI-HUNG LO, P.O.BOX 108-00403, TAIPEI, 106, omitted

(73) Assignee: TSAI-HUNG LO, TAIPEI CITY (TW)

(21) Appl. No.: 12/498,378

(22) Filed: Jul. 7, 2009

(30) Foreign Application Priority Data
Apr. 27, 2009 (TW) 098113941

(51) Int. Cl. G06F 15/173

(52) U.S. Cl. 709/224

(57) ABSTRACT

The present invention provides a network monitoring system and method, wherein the system includes a plurality of monitoring units, each containing a host computer and a camera. Each of the plurality of host computer stores the video images taken by the camera using a monitoring system program, and the monitoring units upload their network addresses to a portal server, so that remote clients can obtain the network addresses of these monitoring units by logging into the portal server. While enabling the remote clients to obtain the video images through connection with the monitoring units via these addresses, this will prevent them from gaining access to the video data by logging into the portal server at the same time, thus helping solve the problem of insufficient bandwidth and speeding up the connection with the server. Besides, once the telephone function of the monitoring units is started, the plurality of voice servers can notify the remote clients of unusual conditions via telephone immediately after that the conditions are found by the monitoring units. Therefore, the present invention will enable the remote clients to obtain the network addresses of the monitoring units by logging into the portal server, so that they can connect to the portal server and watch the video images immediately, achieving the purpose of responding to emergency situations in a real-time manner.

This application claims the priority benefit of Taiwan patent application number 098113941 filed on Apr. 27, 2009.

### BACKGROUND OF THE INVENTION

1. Field of the Invention

The present invention provides a network monitoring system and method. In particular, the present invention provides a method in which network addresses of a plurality of monitoring units are transmitted to a portal server, and made available to remote clients through connection to the portal server. The remote clients can have access to digital video data by further connecting to the monitoring units, thus allowing the digital video data to be distributed in the monitoring units to avoid the problem of insufficient bandwidth.

2. Description of the Prior Art

In case of accidents that often happen in our life, proper measures must be taken to respond and handle, so as to avoid the accidents from deteriorating or generating more serious problems. Therefore, in occurrence of accidents, the proper way to prevent worse situations from occurring is to respond and handle them at the first moment. In life environment, accidents may happen inside and around the houses or outdoors, and the most common accidents occur inside and around the houses, such as gas leakage, fire disasters and intrusion of burglars. Small accidents may lead to pecuniary and wealth losses or injuries of persons that need to be sent to hospitals for treatment, while severe accidents may cause families to be broken up and decimated will or endanger our lives. Hence, if proper preventive measures are taken prior to accidents, it will alleviate the damages caused by these accidents and secure safety of lives and properties.

Currently, the most common preventive measure in response to accidents occurring inside and around the houses is to install a network monitoring system, as shown in FIG. 7, which illustrates the architecture of a conventional system in such regard. According to this figure, a plurality of computers A are installed in indoor or outdoor video cameras Al to detect changes in the ambient environment, and the video images are stored in a master system server B, so that users can watch the video images by connecting to the master system server B. When they find unusual situations in the video images, the users can respond quickly to reduce possible losses caused by accidents.

In general, however, existing network monitoring systems have many disadvantages and problems in practical application as follows:
(1) As the video data are transmitted from the plurality of computers A via a network and stored in the master system server B with a static network address, all users must log into the master system server B for access to these video data. This will potentially lead to the problem of insufficient network bandwidth, and eventually result in delay of transmission time or video asynchrony. Besides, since a large-capacity storage device is additionally required by the plurality of computers A to store the video data and a high-performance processing unit is necessary to process these video data, it will lead to increase in operating costs.
(2) Alternatively, the video data can be stored in the computers A to overcome the bandwidth problem caused by necessary connection of the plurality of computers A to the master system server B. In such case, however, users will find difficulty in downloading the video data, as the network addresses of the computers A are different from each other. The solution is that the computers A must have static network addresses or apply for domain names to Dynamic Domain Name System (DDNS). If the plurality of computers A share a common network address, sub-domain names must be requested or different fixed communication port numbers must be used, and this may require more time or cost to be spent or lead to difficulty in use.
(3) The plurality of computers A will notify users of abnormal video images taken by the video cameras A1 by sending emails, but cannot inform the users via telephone in a real-time way. So if the users do not receive the emails in a real-time way, it will generate time delays that may result in heavy losses.

Thus, how to overcome the problems and disadvantages of a network monitoring system in conventional use is just what the firms involved in this industry need urgently to research and improve.

### SUMMARY OF THE INVENTION

In view of the aforesaid problems and disadvantages, the inventor has collected related information, conducted assessments and taken considerations in many aspects, and based on his own experience of many years in this industry, has finally invented the network monitoring system and method following continuous trials and corrections.

The primary object of the present invention is to provide a system that enables host computers of a plurality of monitoring units to store video images taken by video cameras using a monitoring system program. The video data are stored in the monitoring units, and the monitoring system program uploads network addresses of the monitoring units and communication port numbers thereof to a portal server, so that remote clients can have access to the network addresses of these monitoring units and communication port numbers thereof by logging in the portal server, and further rely on the network addresses to connect with the monitoring units for access to the video data. In this way, the remote clients can download and watch the video data in the monitoring units, thus achieving the purpose of solving the issue of insufficient bandwidth and speeding up network connection.

### BRIEF DESCRIPTION OF THE DRAWINGS

FIG. 1 shows the system architecture of the present invention.

FIG. 2 is an operational flow chart of a system disclosed in the present invention (1).

FIG. 3 is an operational flow chart of a system disclosed in the present invention (2).

FIG. 4 is an operational flow chart of a system disclosed in the present invention (3).

FIG. 5 illustrates the functions of a portal server of the present invention.

FIG. 6 shows a flow chart of voice services according to one embodiment of present invention.

FIG. 7 shows the architecture of a system in conventional use.

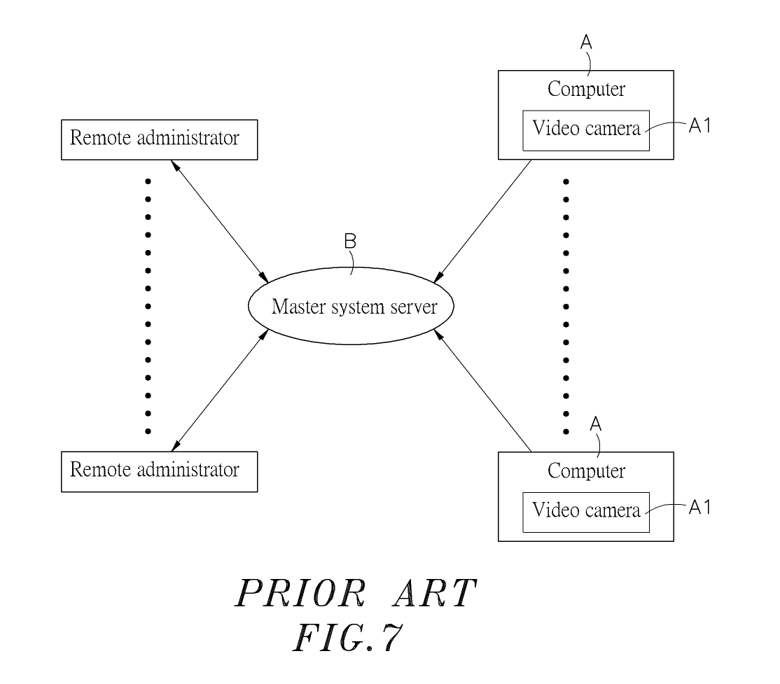

### DETAIL DESCRIPTION OF THE INVENTION

To achieve the aforesaid object and fabrication as well as the techniques applied in the present invention and effects thereof, an example of preferred embodiments of the present invention is given to describe the steps and functions of the present invention in detail with reference to the accompanying drawings.

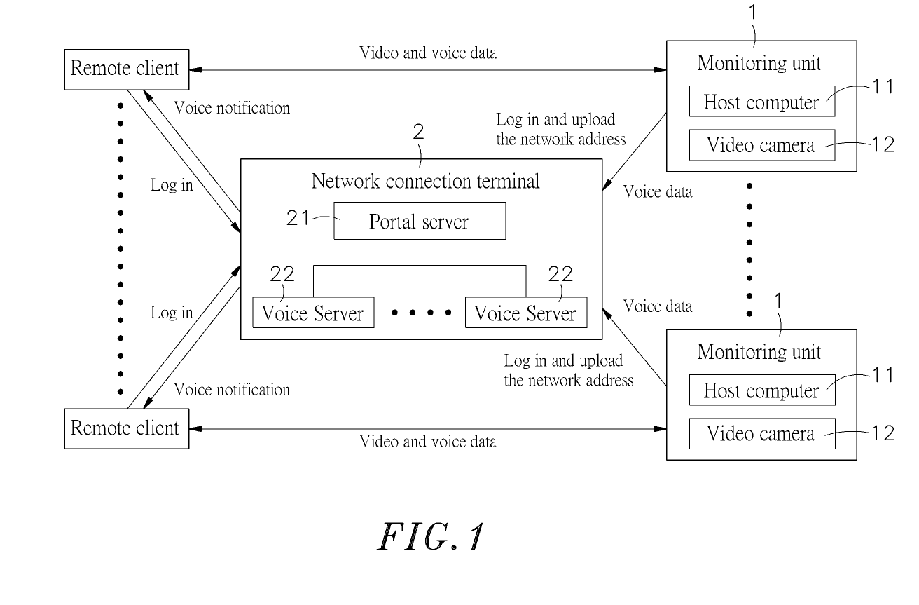

Refer to FIG. 1, which shows the system architecture of the present invention. It can be seen clearly from this figure that:

There is a plurality of monitoring units 1, each comprising a host computer 11 and a video camera 12 respectively, and a monitoring system program is installed in the host computer 11.

A network connection terminal 2 is equipped with a portal server 21 and a plurality of voice servers 22.

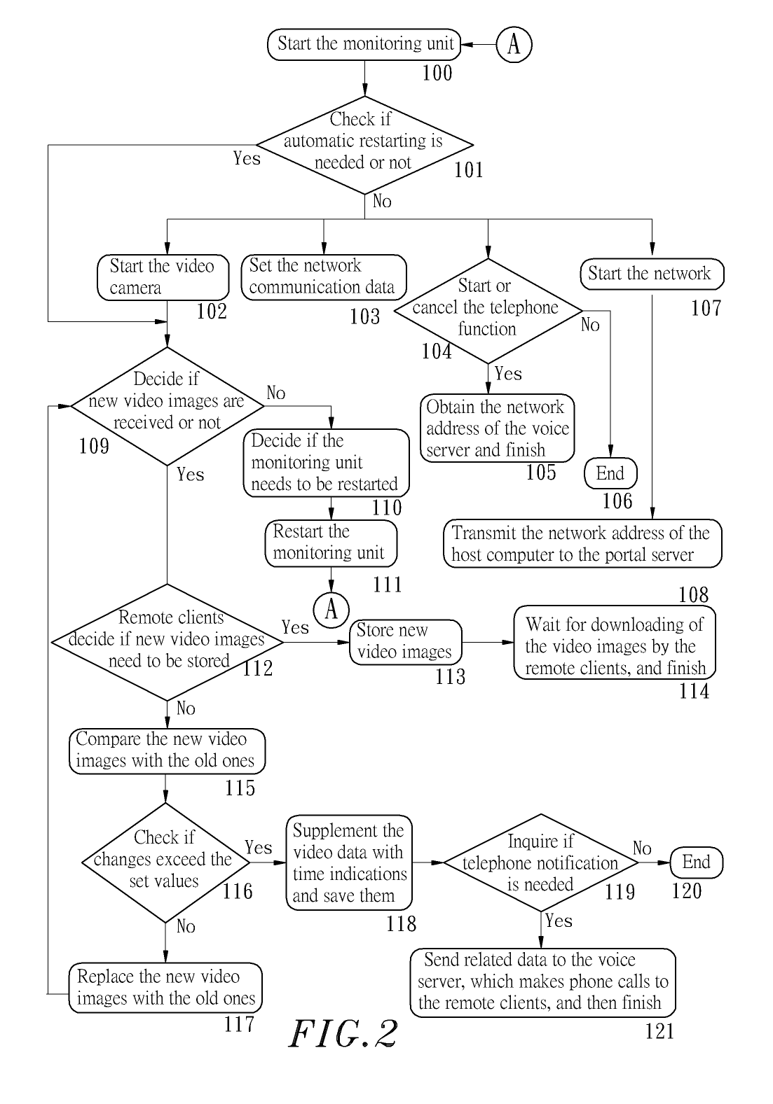

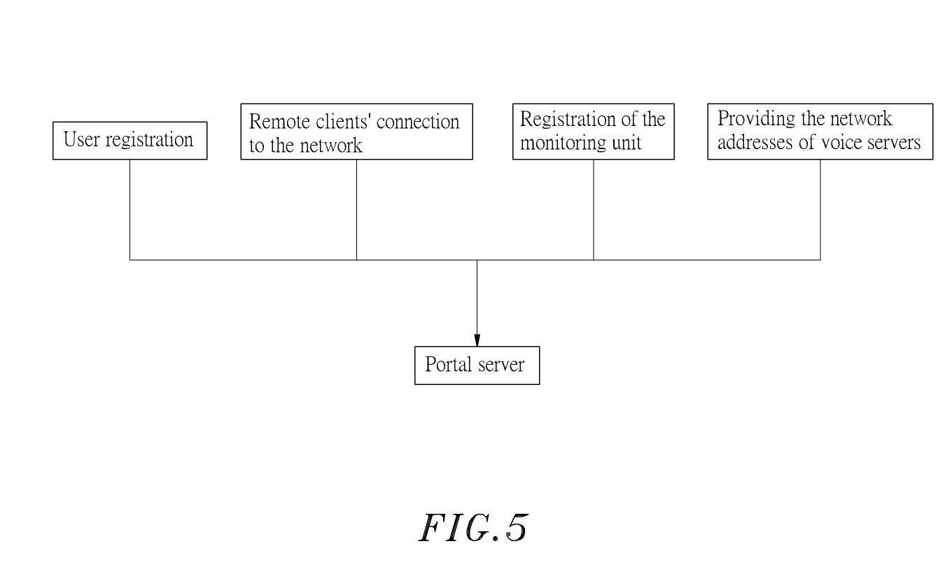

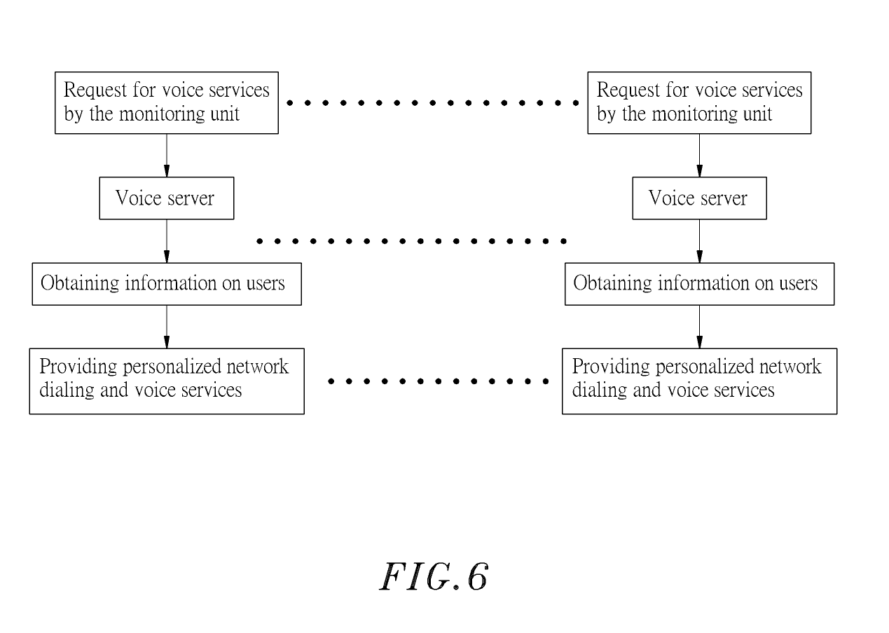

Turn to FIGS. 1, 2, 5 and 6, which show a system architecture, an operational flow chart for a system (1), a function diagram of a portal server and a flow chart for voice services of the present invention respectively. As shown clearly in these figures, the present invention comprises the steps as follows:

(100) start the monitoring unit 1.

(101) check if automatic restarting is needed or not. If yes, proceed to step 109; if not, proceed to steps 102, 103, 104 or 107.

(102) start the video camera 12 and proceed to step 109.

(103) set the network communication data and then finish

(104) start or cancel the telephone function. If the telephone function is started, proceed to step (105); otherwise, proceed to step 106.

(105) obtain the network address of the voice server 22 and finish.

(106) end.

(107) start the network.

(108) transmit the network address of the host computer 11 to the portal server 21.

(109) decide if new video images are received or not. If not, proceed to step 110; otherwise proceed to step 112.

(110) decide if the monitoring unit 1 needs to be restarted.

(111) restart the monitoring unit 1.

(112) remote clients decide if the new video images need to be stored.

(113) store the new video images.

(114) wait for downloading of the video images by the remote clients, and finish.

(115) make a comparison between the new video images and the old ones.

(116) check if changes exceed the set values. If not, proceed to step 117; otherwise, proceed to step 118.

(117) replace the new video image with the old ones, and proceed to step 109.

(118) supplement the video data with time indications and save them.

(119) inquire if telephone notification is needed. If not, proceed to step 120; otherwise proceed to step 121.

(120) end.

(121) send related data to the voice server 22, which makes phone calls to the remote clients, and then finish.

Each of the plurality of monitoring units 1 contains the host computer 11 connected with the video camera 12, and the monitoring system program is installed in the host computer 11. When the monitoring unit 1 does not work normally, users can decide whether it is necessary to restart the monitoring unit 1. If the answer is yes, the users shall check and decide whether they can receive the new video images taken by the video camera 12. If they cannot, the users may choose to start the video camera 12, set network communication data, start/cancel the telephone function, or start the network. After having selected to start the video camera 12, the users shall check if they can receive the new video images taken by the video camera 12. The users may choose to set the network communication data (e.g. user ID and password, etc.) before using the video camera 12 for the first time, so that they do not need to enter these data next time when the video camera 12 is started automatically. In addition, the users may start or cancel the telephone function of the monitoring unit 1. If such function is started, the monitoring unit 1 will obtain the network address of the voice server 22; if cancelled, this step will finish. When the users select to start the network function, any of the monitoring units 1 can register with the portal server 21. The network address and communication port No. of the monitoring unit 1 will be transmitted to the portal server 21 at regular intervals, and the largest pieces of the stored video data will be made available to the remote clients, so that they can obtain the network address and communication port No. of the monitoring unit 1 by connection to the portal server 21. Then the remote users can connect to the monitoring unit 1 via the network address and gain access to the video data.

When finding out that the monitoring unit 1 receives no new video image, the users should decide whether it is necessary to restart the monitoring unit 1 or not. If it is necessary, they need to exercise another program to restart the monitoring unit 1. Moreover, when the monitoring unit 1 can receive new video images, the remote clients may decide whether to store these new video images. If not, the monitoring unit 1 will make a comparison between the new video images and the old ones; if yes, the video data will be stored and downloaded by the remote users till the downloading is over.

As described in the preceding paragraphs, the monitoring unit 1 will check if the changed values exceed the set values or not before making a comparison between the new video images and the old ones; if not, it will overwrite the old video images with the new ones, and start a new round of video recording; and if yes, it will supplement the video data with time indications and then store these video data. The monitoring unit 1 will ask if the users require telephone notifications from the voice server 22. If such service is required, the monitoring unit 1 will transmit related data to the voice server 22, which will make phone calls to the remote clients. If such service is not needed, this step will come to an end.

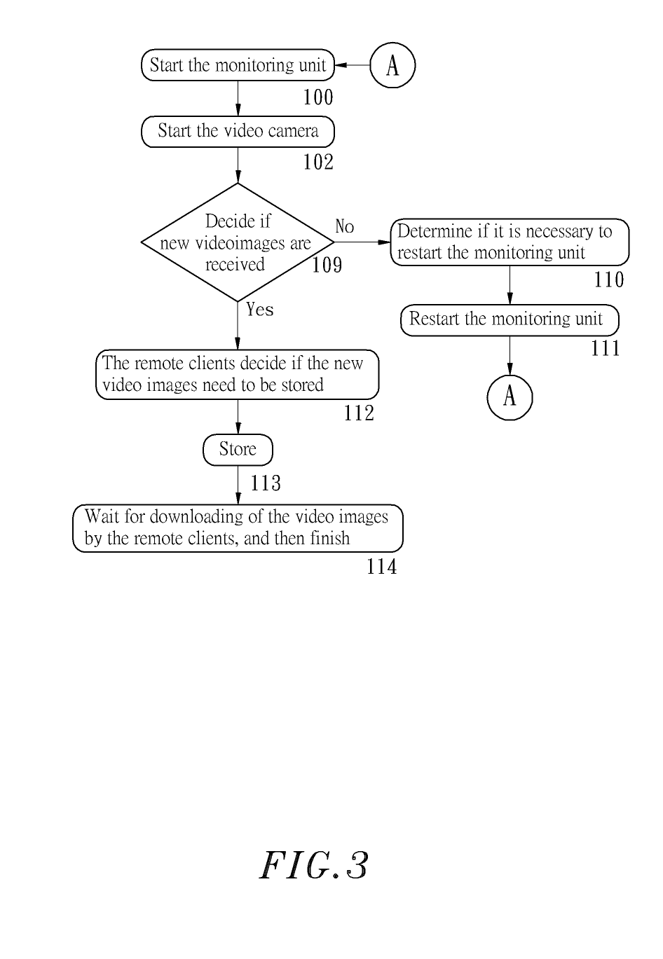

Refer to FIG. 3, which is an operational flow chart of a system disclosed in the present invention (2). As show clearly in this figure, the operational steps of the system in the present invention are as follows:
(100) start the monitoring unit 1.
(102) start the video camera 12 and proceed to step 109.
(109) decide if new video images are received; if not, proceed to step 110; otherwise proceed to step 112.
(110) determine if it is necessary to restart the monitoring unit 1.
(111) restart the monitoring unit 1.
(112) the remote clients decide if the new video images need to be stored.
(113) store the new video images.
(114) wait for downloading of the video images by the remote clients till downloading is over.

Users shall check whether they can receive the new video images taken by the video camera 12 or not when they control the monitoring unit 1 to start the video camera 12. If they find the monitoring unit 1 unable to receive new video images, the users shall decide whether it is necessary to restart the monitoring unit 1 or not. If it is necessary, they need to exercise another program to restart the monitoring unit 1. In addition, when the monitoring unit 1 can receive new video images, the remote users may decide whether to store the new video images or not. If they decide not to store the new video images, the monitoring unit 1 will compare the new video images with the old ones; if they choose to store the new video images, the monitoring unit 1 will save these new video data, wait for downloading of the video data by the remote users, and then finish.

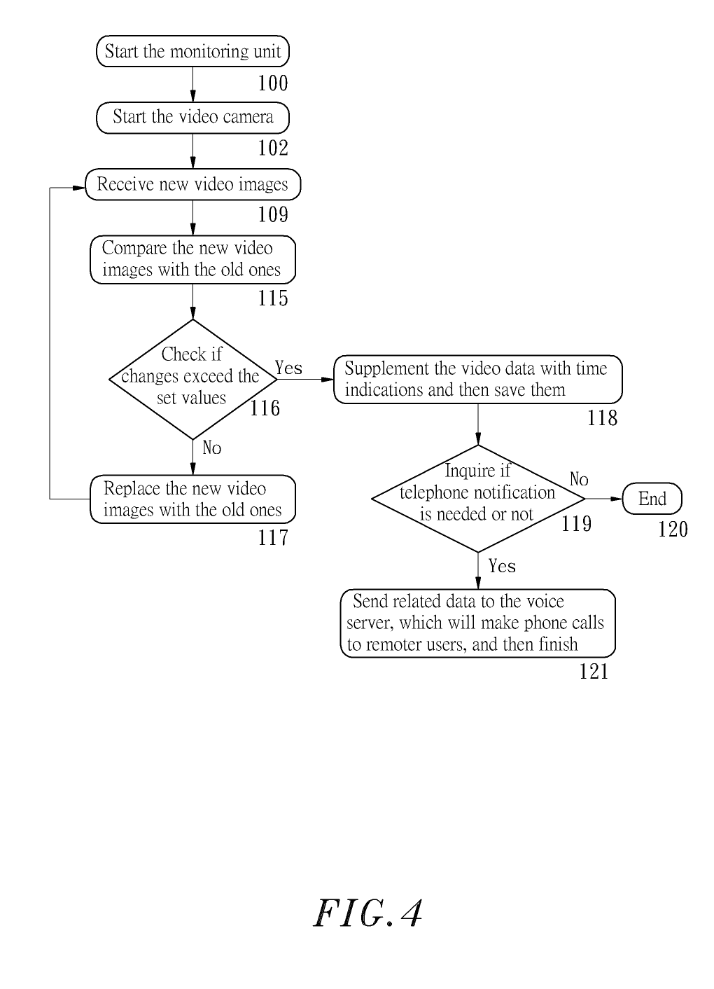

Turn to FIG. 4, which is an operational flow chart of a system disclosed in the present invention (3). As show clearly in this figure, the operational steps of the system in the present invention are as follows:
(100) start the monitoring unit 1.
(102) start the video camera 12 and proceed to step 109.
(109) receive new video images and proceed to step 115.
(115) compare the new video images with the old ones.
(116) check if changes exceed the set values; if not, proceed to step 117; otherwise proceed to step 118.
(117) replace the new video images with the old ones, and proceed to step 109.
(118) supplement the video data with time indications and then save them.
(119) inquire if telephone notification is required or not; if not, proceed to step 120, otherwise, proceed to step 121.
(120) end
(121) send related data to the voice server 22, which will make phone calls to the remoter users, and then finish.

When users operate the monitoring unit 1 to start the video camera 12, they can receive the new video images taken by the video camera 12, and the monitoring unit 1 will compare the new video images with the old ones and check if the changed values exceed the set values or not. If not, the monitoring unit 1 will overwrite the old video images with the new ones and start a new round of video recording. If the changed values exceed the set values, the monitoring unit 1 will add time indications to the video data and then store these data. Next it will inquire if the users require telephone notifications from the voice server 22. If telephone notification is needed, the monitoring unit 1 will transmit related data to the voice server 22 which will further notify the remote users via telephone; if telephone notification is not required, the monitoring unit 1 will conclude this step.

In practical applications, the network monitoring system and method disclosed in the present invention has such advantages as follows:
(1) Since the video data are stored in the respective host computer 11 of the monitoring unit 1, all remote clients can have access to the network address of the monitoring unit 1 by logging into the portal server 21, and further to the video images through connection to this network address. Therefore, the video images may not be necessarily stored in the portal server 21 for downloading by the remote clients; instead, the video images can be stored in the plurality of monitoring units 1 for downloading by the remote clients, thus allowing the network to be connected at a faster speed.

(2) When finding unusual conditions in the video images, the monitoring unit 1 will send signals to the plurality of distributed voice servers 22, which will notify the remote clients via telephone immediately, and the remote clients can gain access to the network address of the monitoring unit 1 by logging in the portal server 21. Therefore, the remote clients can watch the video images online immediately to strengthen the monitoring function of the monitoring system. This will facilitate the remote clients to respond immediately and mitigate the seriousness of disasters.

(3) The monitoring unit 1 stores the video data only at the request of the remote clients, and the remote clients can decide on the number of the video data to be stored. This allows the remote clients to monitor the video data and help to reduce the consumption of resources and memory capacity of each host computer 11.

(4) Based on a real-time video image recorded by the monitoring unit 1, the remote clients can skim through several video data before or after it. This enables the remote clients to look at the video data completely and clearly.

The above descriptions are given to illustrate one example of the preferred embodiments of the present invention, and shall not be construed as a limitation on the scope of the appended claims of the present invention. It is hereby declared that all modifications and equivalent structural changes made without departing from the spirit of the art and scope disclosed in the present invention shall be included in the patent claims of the present invention.

To sum up, the network monitoring system and method of the present invention as described above can really achieve its functions and objectives. Therefore, the present invention is really an excellent one with practical applicability, and can satisfy the conditions for patentability of a utility model. While the application of patent is filed pursuant to applicable laws, your early approval of the present invention will be highly appreciated so as to guarantee benefits and rights of the inventor who has worked hard at this invention. For any question, please do not hesitate to inform the inventor by mail, and the inventor will try his best to cooperate with you.

What the invention claimed is:

1. A network monitoring system comprising a plurality of monitoring units and a network connection terminal, wherein each of the plurality of monitoring units has a host computer and a camera, and a monitoring system program is installed in the host computer; the network connection terminal is equipped with a portal server and a plurality of voice servers and the network address of each host computer will be uploaded to the portal server at regular intervals, and the plurality of monitoring units can detect and store video images taken by the video camera, when finding unusual video signals, each of the monitoring units will immediately send signals to notify remote clients of the abnormalities; the remote clients can log into the portal server to obtain the network address of each host computer, and connect to the monitoring units via the network address for access to the video images.

2. The network monitoring system according to claim 1, wherein, when any of the monitoring units detects unusual video images, the plurality of voice servers will notify the remote clients via phone calls or short messages, and transmit the network address of the said monitoring unit to the remote clients, so that they can watch the unusual video images by connecting to the monitoring unit.

3. A network monitoring method, comprising the steps of:
(A) Start the monitoring unit;
(B) Check if the monitoring unit needs to be restarted or not; if yes, proceed to step D; and if not, proceed to step C;
(C) Start the video camera;
(D) The host computer will receive and store new video images for monitoring;
(E) Start the network;
(F) Transmit the network address of the host computer to a portal server;
(G) Remote clients decide to store the new video images;
(H) Store video data;
(I) Wait for remote clients to download the video images.

4. The network monitoring method according to claim 3, wherein users shall check if it is necessary to restart the monitoring unit automatically in step B, if it is not necessary, the users may choose to set the network communication data or start/cancel the telephone function, when the telephone function is started, the plurality of voice servers will transmit the network addresses of the host computers to the remote clients, and the monitoring unit will compare the new video images with the old ones and check if the set values are exceeded or not, further if the set values are not exceeded, the monitoring unit will overwrite the old video data with the new ones and then start a new round of video recording; if the set values are exceeded, the monitoring unit will add time indications to the video data and store these data, and further inquire if the users need telephone notification from the voice servers, if telephone notification is required, the monitoring unit will send related information to the voice server, which will make phone calls to the remote clients.

5. The network monitoring method according to claim 3, wherein it shall be decided whether the monitoring unit can receive and store new video images in step D, and the monitoring unit will have access to the new video images if it can receive these images; otherwise it shall be decided if it is necessary to restart the monitoring unit, if it is necessary, restart the monitoring unit.
